(19) United States
(12) Patent Application Publication
(10) Pub. No.: US 2004/0268344 A1
(43) Pub. Date: Dec. 30, 2004

(54) Centrally managed and distributed applications

(76) Inventor: Sridhar Obilisetty, Milpitas, CA (US)

Correspondence Address: WAGNER, MURABITO & HAO LLP, Two North Market Street, Third Floor, San Jose, CA, 95113, US

(21) Appl. No.: 09/803,514

(22) Filed: Mar. 8, 2001

(51) Int. Cl. G06F 9/445

(52) U.S. Cl. 717/175; 717/120; 717/169

(57) ABSTRACT

A method and system thereof for distributing, implementing and managing applications on computer systems, in particular client computer systems coupled to server computer systems in a network. A client-based shell program downloads and installs text-based files, such as files that are written using an Extensible Markup Language (XML) syntax. The XML files define different components (objects) of an application. The shell program meshes the XML files to create the application. The application can be updated by downloading and installing a new version of an XML file. The application can be executed on a client computer system with or without a network connection to a server computer system. The application can also be executed on the client computer system while waiting for a response from the server to a preceding request. Thus, the functionality of a “fat” client is provided in a “thin” client.

### TECHNICAL FIELD

The present invention relates generally to computer system networks. In particular, the present invention pertains to a method and system for distributing, implementing and managing applications across networks of computer systems.

### BACKGROUND ART

Before computer system networks became prevalent, computer systems were primarily stand-alone devices. Software applications were written to perform specific functions and, in general, did not have the capability to communicate and exchange data over a network. However, as networks became common, software applications evolved to facilitate communication and the exchange of data and information over a network.

Depending on the approach used in the network, the client computer systems can be either “fat” clients or “thin” clients. In general, with a fat client, only data are resident on the server computer system. The business logic, presentation logic, and the like used by an application are installed on the client. The application on a fat client retrieves and updates the data maintained by the server.

With a thin client, generally speaking, the business logic, presentation logic, and data reside on a server and are downloaded to the client when needed. In a Web-based architecture, the client is a Web browser, the server is a Web server, and standard Internet protocols are used for data transport. Basically, a Web browser, which is an instance of a thin client, sends a request to the Web server, and the server processes the request and sends a response back. The functions of the Web server may be divided among one or more tiers of servers that perform more specialized functions, such as an application server that executes an application and a database server that stores and retrieves data for the application server. In any case, in essence, the Web server(s) perform the functions while the capabilities of the Web browser (thin client) are somewhat limited.

A problem with the fat client approach is that the deployment of new or different software, such as application upgrades, to each client computer system can be expensive as well as administratively burdensome. Once a client has been designed and developed, its functionalities are relatively fixed, and so it is expensive to change or add new services, and to deploy the new software to all clients. Furthermore, when a computer system platform different from the platform the application was designed for is introduced to the network, the application needs to be ported for the new platform. This too can be expensive and time-consuming. Thus, the fat client approach is problematic with regard to upgrading and distributing applications to client computer systems across the network.

The thin client approach of the prior art addresses some of the problems associated with the fat client approach, but some challenges remain, particularly with regard to thin clients in Web-based architectures run on the Internet. One such challenge is that the client and server need to be connected in order for them to interact. Consequently, in the prior art, enterprises cannot afford to depend on the thin client approach for important transactions because of those instances when a connection cannot be made, even if those instances occur infrequently.

Another challenge faced with thin clients in Web-based architectures is that communication delays can slow the processing of requests and transactions. The Internet Protocol (IP) cannot guarantee timely delivery of data packets to a destination. Real-time and business-critical IP traffic typically cannot tolerate excessive delays or packet losses. While some efforts can be made to improve the reliability and speed of an in-house network, this is not an option when working over a public network such as the Internet. Moreover, any advantage provided by an in-house network is largely offset by the cost of maintaining such a network, a cost that is not associated with the use of the Internet.

Another challenge associated with thin clients in Web-based architectures is that the user interface provided to the client for Web-based applications is typically in the form of HTML (HyperText Markup Language) pages which are individually downloaded and assembled by the client's Web browser. Compared to the user interface for client-based applications, a user interface provided in this manner is not as rich or compelling to the user. The user might also find that many of the menu items available in a client-based application are not available for a Web-based application. In addition, while there are techniques in place for facilitating the downloading of HTML pages, the client-based user may still experience a degree of inconvenience and delay associated with locating and downloading an HTML page and waiting for the page to be built on the client device.

Yet another challenge faced with thin clients in Web-based architectures is that the HyperText Transfer Protocol (HTTP) standard used in the prior art is oriented toward synchronous communication between a client and a server. The client makes a request to a server and transfers data and control to the server as part of the request. Operation in the synchronous mode means the client is blocked from further execution of the request until a response is received from the server. Thus, the thin client approach of the prior art can lead to unsatisfactory performance because of the HTTP request/reply model currently in use, and the resultant blockage of further program execution.

As a result of these problems, networks, and in particular the Internet, are relegated primarily to a role of transferring content only for non-critical transactions between client and server devices.

Thus, to summarize, maintaining, updating and distributing applications installed on fat clients can be costly and time-consuming, even when the client systems are networked. However, even with thin clients, challenges remain because of the limitations associated with Web browsers, network reliability, communication and processing, and the user interface.

Accordingly, what is needed is a method and/or system for maintaining, upgrading, and distributing applications and updates to client computer systems efficiently and at reduced cost. What is also needed is a method and/or system that can satisfy the above needs and that maintains high performance and reliability and a satisfactory user interface. The present invention provides a novel solution to the above needs.

### DISCLOSURE OF THE INVENTION

The present invention provides a method and system for maintaining, upgrading, and distributing applications and updates to client computer systems efficiently and at reduced cost. The present invention also provides a method and system that satisfy the above need, maintain high performance and reliability, and provide a satisfactory user interface.

In general, the present invention provides a centrally managed architecture for distributing and maintaining applications. In essence, the present invention distributes application-related information between a server and one or more clients by exchanging files (such as Extensible Markup Language files) on a periodic basis over the Internet. On the clients is an agent that works in combination with those files to create applications on the clients that have rich user interfaces and locally cached business logic. The present invention thus provides a “thin” client with the functionality of a “fat” client.

The files are distributed transparently to the user; that is, the files are “pushed” to the clients or “pulled” from the server automatically over the network, and the applications are assembled automatically from the files. In a similar fashion, applications are seamlessly and automatically updated by downloading updated versions of files from the server, either as the updates become available or on a periodic basis. Thus, in accordance with the present invention, new applications and application updates can be distributed to a multiplicity of clients from a centrally managed source (e.g., the server). The user, working at a client computer system, is automatically provided with a fully functional and up-to-date application resultant from the exchange of files between the client and the server.

Significantly, the applications can be executed on the client independent from the server in an “asynchronous mode;” that is, the interaction of the user with a client-based application is independent of the interaction of that application with the server. The client-based applications are complete enough to perform activities (e.g. support user interactions) while waiting for a response from the server to a previous request. In addition, the client-based applications are complete enough to be executed on the client with or without a connection between the client and the server.

Specifically, the present embodiment of the present invention pertains to a method and system thereof for distributing, implementing and managing applications across a plurality of computer systems using a centrally managed source. In particular, the present invention pertains to a method and system for distributing and updating applications on client computer systems coupled to server computer systems in a network (e.g., the Internet or an Intranet). In the present embodiment, an application includes components (objects) that define the application's graphical user interface, business logic (including the functions and operations performed by the application), communication logic and preferences, and data management (such as the exchange of data between components).

In accordance with the present invention, the components (objects) used to build applications on the client computer systems are defined using text-based files. A “shell” program (e.g., agent) is installed on the client computer systems. The client-based shell program is used for downloading and installing the text-based files from a server. The shell program meshes the text-based files received from the server to create different client-based applications with rich user interfaces.

In one embodiment, the text-based files are written using an Extensible Markup Language (XML) syntax. As such, applications can be defined by application developers in XML according to their components (objects), which are submitted via a server to the shell program residing on the client computer systems and meshed to form the application. Upgrades to applications are accomplished in much the same manner, by creating new objects or modifying existing ones, and downloading the new object via a server to the clients. That is, in the present embodiment, the client-based applications can be readily updated by downloading and installing a new version of an XML file. The server provides a centrally managed source for distributing applications and upgrades to a multiplicity of clients. Thus, in accordance with the present invention, applications can be rapidly developed and upgraded with substantially reduced administration costs.

In addition, with a centrally managed source of applications in accordance with the present invention, applications can be customized across a network of client computer systems (on a business-by-business basis, for example) or customized for each client computer system within a particular business, by downloading the appropriate files on a business-by-business or device-by-device basis. That is, specific files providing a customized version of an application can be targeted to a particular group of clients or to a single client.

In accordance with the present invention, any client application as well as the client's Web browser can communicate via Internet protocols. However, the applications can be executed on the client computer systems with or without a network (e.g., Internet or Intranet) connection to a server computer system. In the absence of a network connection, because the application is built on the client computer system, the user can still utilize all of the application's functionality. In addition, the application can continue to support user interactions (e.g., execute a function) while waiting for the server to respond to an earlier request or requests. Data are stored locally and, if necessary, uploaded to the server when the network connection is restored.

Thus, in accordance with the present invention, the synchronous/connection-oriented communication model of the prior art is replaced with an asynchronous/connectionless model. Accordingly, enterprises can successfully migrate their mission-critical applications to the World Wide Web, instead of relying on proprietary electronic data interchange (EDI) networks, leased phone lines, satellite networks and the like, while preserving high performance execution and timely responses to the end-user and providing a rich user interface on the client side. As such, the present invention allows the use of the Internet as a true universal communication medium.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary computer system upon which embodiments of the present invention may be practiced.

FIG. 2 is a block diagram of an exemplary network of computer systems upon which embodiments of the present invention can be implemented.

FIGS. 3A, 3B and 3C are data flow diagrams illustrating the use of text-based files to build applications in accordance with the present invention.

FIG. 4 is a data flow diagram showing the interaction of application objects in accordance with one embodiment of the present invention.

FIG. 5 is a flowchart of the steps in a process for building applications from text files in accordance with one embodiment of the present invention.

### BEST MODE FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, fragments, pixels, or the like.

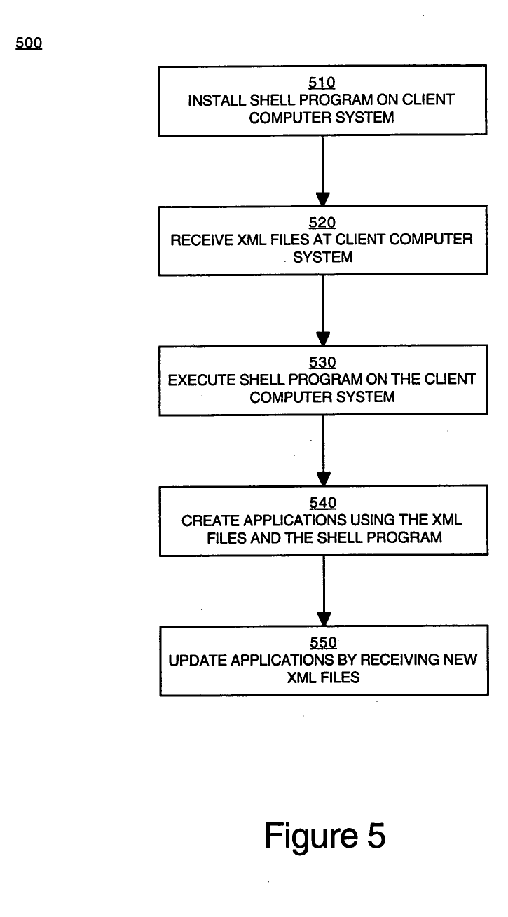

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “executing,” “creating,” “installing,” “using” or the like, refer to actions and processes (e.g., process 500 of FIG. 5) of a computer system or similar electronic computing device. The computer system or similar electronic computing device manipulates and transforms data represented as physical (electronic) quantities within the computer system memories, registers or other such information storage, transmission or display devices. The present invention is well suited to the use of other computer systems.

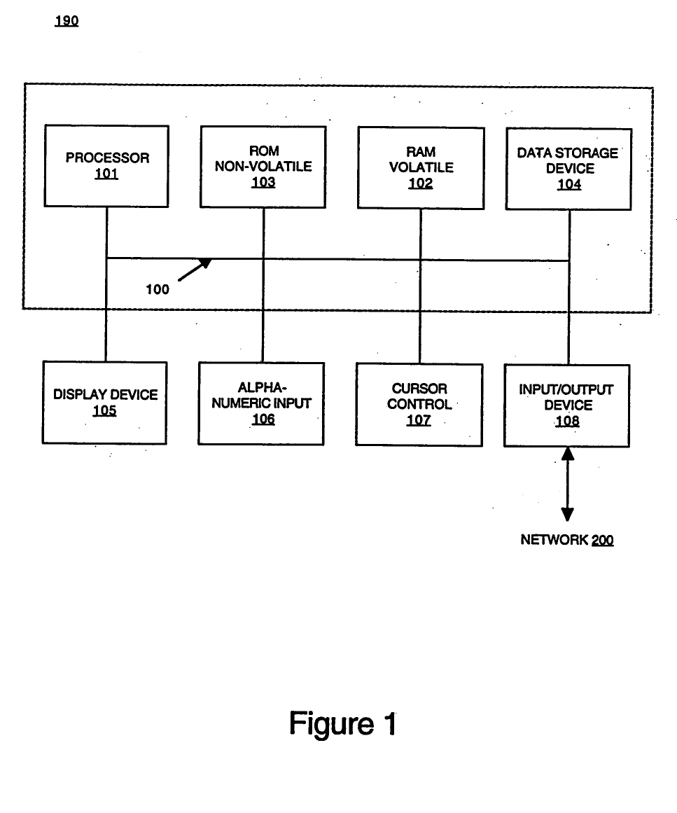

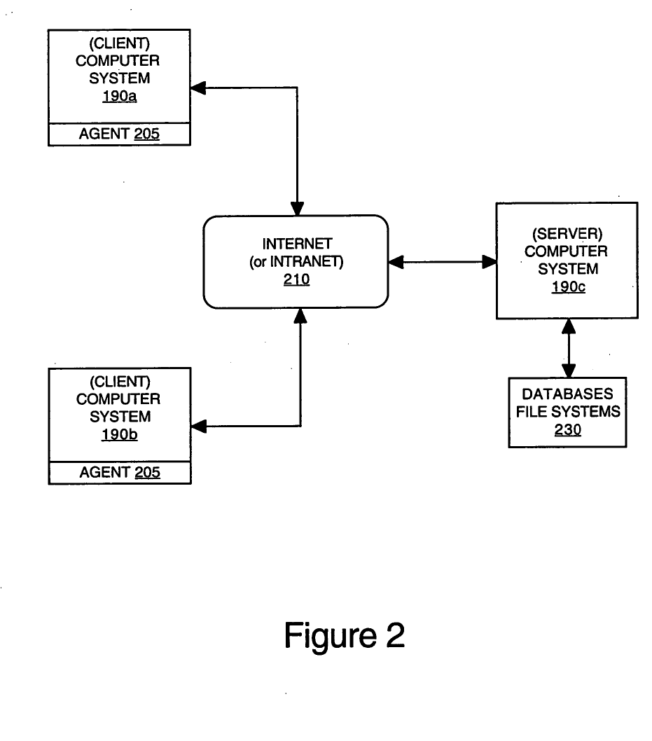

Refer now to FIG. 1 which illustrates an exemplary computer system 190 upon which embodiments of the present invention may be practiced. Computer system 190 may be utilized as a client computer system or as a server computer system in a computer system network 200 (see FIG. 2). In general, computer system 190 of FIG. 1 comprises bus 100 for communicating information, processor 101 coupled with bus 100 for processing information and instructions, random access (volatile) memory 102 coupled with bus 100 for storing information and instructions for processor 101, read-only (non-volatile) memory 103 coupled with bus 100 for storing static information and instructions for processor 101, data storage device 104 such as a magnetic or optical disk and disk drive coupled with bus 100 for storing information and instructions, an optional user output device such as display device 105 coupled to bus 100 for displaying information to the computer user, an optional user input device such as alphanumeric input device 106 including alphanumeric and function keys coupled to bus 100 for communicating information and command selections to processor 101, and an optional user input device such as cursor control device 107 coupled to bus 100 for communicating user input information and command selections to processor 101. Furthermore, input/output device 108 is used to couple computer system 190 to network 200.

With reference still to FIG. 1, optional display device 105 utilized with computer system 190 may be a liquid crystal device, cathode ray tube, or other display device suitable for creating graphic images and alphanumeric characters recognizable to the user. Optional cursor control device 107 allows the computer user to dynamically signal the two-dimensional movement of a visible symbol (pointer) on a display screen of display device 105. Many implementations of the cursor control device are known in the art including a trackball, mouse, joystick or special keys on optional alphanumeric input device 106 capable of signaling movement of a given direction or manner of displacement. It is to be appreciated that the cursor control 107 also may be directed and/or activated via input from the keyboard using special keys and key sequence commands. Alternatively, the cursor may be directed and/or activated via input from a number of specially adapted cursor directing devices.

FIG. 2 is a block diagram of computer systems 190a, 190b and 190c coupled in an exemplary network 200 upon which embodiments of the present invention can be implemented. Network 200 may represent a portion of a communication network located within a firewall of an organization or corporation (an “Intranet”), or network 200 may represent a portion of the World Wide Web or Internet. It is appreciated that the present invention can be utilized with any number of client and network computer systems.

The mechanisms for coupling computer systems 190a, 190b and 190c over the Internet Or Intranets 210 are well-known in the art. In the present embodiment, standard Internet protocols like IP (Internet Protocol), TCP (Transmission Control Protocol), HTTP (HyperText Transfer Protocol) and SSL (Secure Sockets Layer) are used to transport data between clients and servers, in either direction. However, the coupling of computer systems 190a, 190b and 190c can be accomplished over any network protocol that supports a network connection, including NetBIOS, IPX (Internet Packet Exchange), and LU6.2, and link layers protocols such as Ethernet, token ring, and ATM (Asynchronous Transfer Mode). Computer systems 190a, 190b and 190c may also be coupled via their respective input/output ports (e.g., serial ports) or via wireless connections (e.g., according to IEEE 802.11b).

With reference still to FIG. 2, in the present embodiment, residing on each client computer system 190a-b is an agent 205. Agent 205 is a software program or set of computer-readable program instructions that implements the present invention method for implementing, updating and distributing applications. In one embodiment, agent 205 is a “shell” program that is installed on client computer systems 190a-b. As such, agent 205 is a generic program that can be installed on different computer system platforms. After installation, agent 205 downloads files from server computer system 190c (e.g., from databases and file systems 230 that are either resident on server 190c, or accessible by server 190c).

In accordance with the present invention, the files downloaded by agent 205 are text-based files. In one embodiment, the files are written using an Extensible Markup Language (XML) syntax. Because information in an XML file is stored in plain text, the format facilitates the movement of data over the Internet from the client to the server and back.

In accordance with the present invention, agent 205 then assembles the text-based files to create applications that are executable by client computer systems 190a-b. In the present embodiment, an application consists of a number of components or objects that, when combined by agent 205, define the GUI (graphical user interface), business logic, communication preferences, and data management and exchange logic for the application. In accordance with the present embodiment of the present invention, these components are defined in XML files and submitted via server computer system 190c to agent 205. Agent 205, together with the XML files, forms each application. The XML files are thereby used to define the GUI and associated actions; to define business rules like work flow; and to facilitate the exchange of information between different objects. In the, present embodiment, the XML format is also used to define the content of data, as well as the structural relationships that exist inside the data.

For example, for a word processing application, a GUI comparable that used by conventional word processing applications can be defined by the XML files. The functions executed by a word processing application can be defined by another set of XML files (e.g., the business logic files). The flow of information between the XML files can be defined by another set of XML files (e.g., the data management files) and appropriately managed by agent 205. The frequency with which word processing documents are to be uploaded to server computer system 190c can be defined in yet another set of XML files (e.g., the communication preferences files).

Because agent 205 creates the GUI, business logic, communication preferences, and data management logic from the XML files, it needs to be installed only once on each of client computer systems 190a-b. Further client-side installations of agent 205 are not required or are minimized. A generic set of information (e.g., agent 205) is thus installed initially on the clients, and the information from the server is used to define different applications in combination with the agent 205.

On the other hand, the XML files can be downloaded from server computer system 190c each time the application is used, or the files can be cached locally on each of client computer systems 190a-b. Also, updated versions of each file can be downloaded from server computer system 190c when a newer version of a file becomes available, thereby enabling the application to be readily updated. In accordance with the present invention, there is no need to edit and recompile the application to change one or more of its functions or operations; instead, the XML file associated with the function/operation is edited and downloaded from server computer system 190c to the client computer systems 190a-b. Consequently, the present invention introduces central management of applications, and can reduce the administration costs associated with the distribution of application upgrades.

In one embodiment, agent 205 automatically checks server computer system 190c for updated versions of files used by the applications loaded onto client computer systems 190a-b. In this embodiment, the frequency at which agent 205 checks for updated files can be set in the file that controls communication logic and preferences. As described above, files from server computer system 190c can be downloaded when the application is used or when new files are available. In accordance with the present invention, files can be “pulled” by client computer systems 190a-b from server computer system 190c, or “pushed” from server computer system 190c to client computer system 190a and/or 190b.

The files are distributed transparently to the user; that is, the files are pushed to the client or pulled from the server automatically over the network 200. Similarly, applications are seamlessly and automatically updated by periodically downloading new files to client computer systems 190a-b from server computer system 190c.

Because the applications can reside locally on each of client computer systems 190a-b, asynchronous communication between client computer systems 190a-b and server computer system 190c is enabled with the present invention. In accordance with the present invention, the application can be executed on a client computer system 190a or 190b asynchronously from the server computer system 190c. That is, the interaction of the user with the client-based application is independent of the interaction of the client-based application with the server.

Asynchronous communication between client computer systems 190a-b and server computer system 190c allows a user to engage in other, productive activities while waiting for another activity to conclude. That is, in contrast to a synchronous mode in which a client is blocked from further execution of an activity until a response is received from the server, the asynchronous mode of the present invention allows the application to continue support of user interactions (such as the typing in and saving of text) in parallel with (while waiting for) the server to respond to a previous request or requests. In accordance with the present invention, a request can be sent to the server, work can continue on the client before a response to the request is received, another request can be sent to the server before the response to the first request is received, and so on.

Also, with asynchronous communication, applications can support user interactions, such as the typing in and saving of text, even in the absence of a network connection. In accordance with the present invention, if a connection between the client (e.g., 190a) and server 190c is dropped, a user can still utilize the application's functionality. The user input and other such client-based data can be saved locally on client 190a and uploaded to the server 190c when the connection is restored. Because a connection between a client (e.g., 190a) and a server 190c is not required in order to execute an application, the present invention allows the Internet (or Intranet) 210 to be used as a universal communication medium suitable to run mission-critical operations.

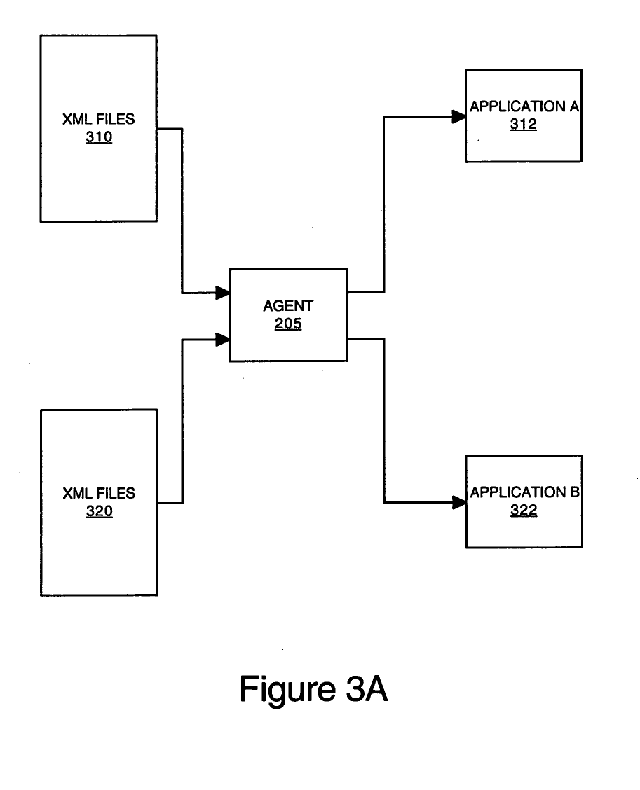

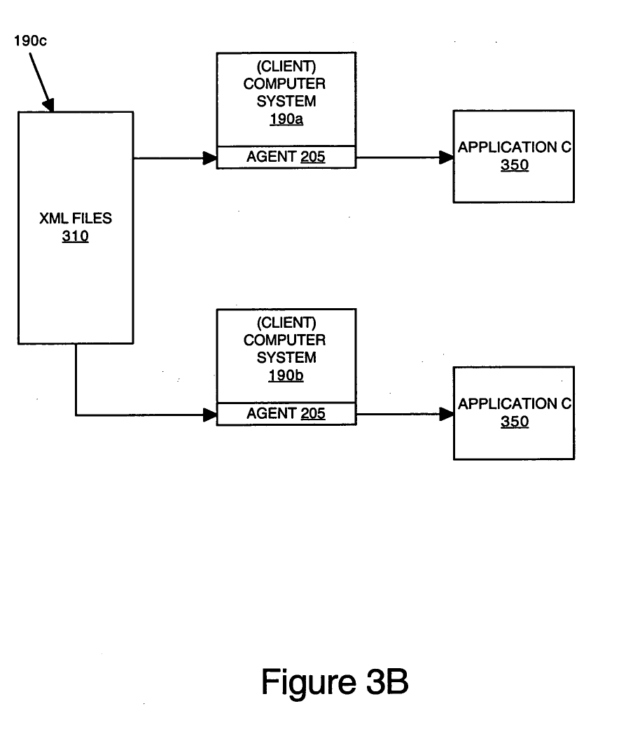

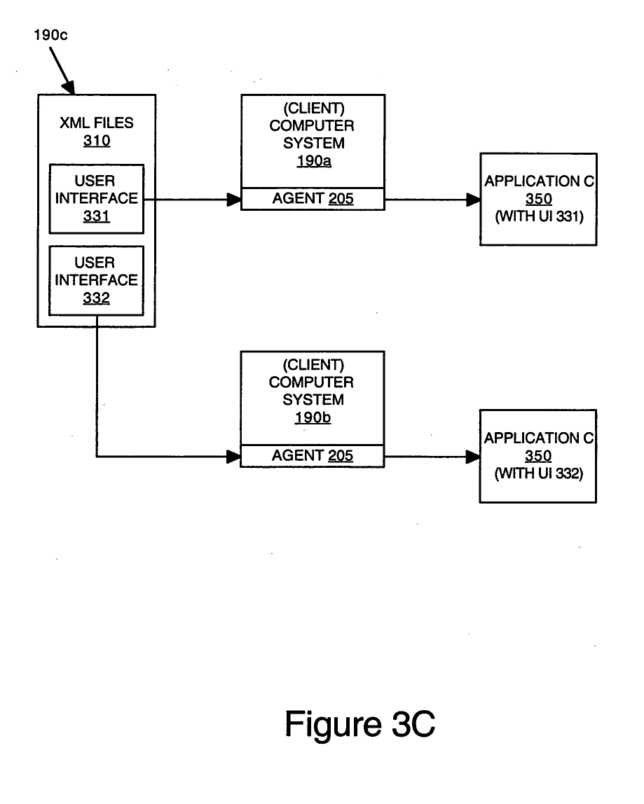

FIG. 3A is a data flow diagram illustrating the use of text-based files to build applications in accordance with one embodiment of the present invention. In this embodiment, different sets of XML files 310 and 320 are downloaded to client computer system 190a from a server such as server computer system 190c (FIG. 2). The set of XML files 310 correspond to a first application A 312, and the set of XML files 320 correspond to a second, different application B 322. In accordance with the present invention, the XML files 310 are assembled with agent 205 to create application A 312, resident and executable on client computer system 190a. Similarly, the XML files 320 are assembled with agent 205 to create application B 322, also resident and executable on client computer system 190a. Thus, in this embodiment, different applications are built according to the information specified in the XML files 320 and 322.

FIG. 3B is a data flow diagram illustrating the use of text-based files to build applications in accordance with another embodiment of the present invention. In this embodiment, a set of XML files 310 is downloaded to each of client computer systems 190a and 190b from server computer system 190c. The set of XML files are assembled with agent 205 residing on the client computer systems to create application C 350 on each of the clients. Thus, in this embodiment, the application C 350 is readily distributed from the server to each of the clients. In this manner, an application or set of applications can be distributed to each client computer system across a business, on a business-by-business basis.

It will be understood that a similar technique can be used to distribute application updates to each of the clients. For example, one or more of the XML files in the set of XML files 310 can be modified, and that file or files can then be distributed to each of client computer systems 190a and 190b. Because an XML file is written in plain text, modification of such a file to upgrade an application is readily performed. Thus, application C 350 can be quickly updated in accordance with the present invention.

FIG. 3C is a data flow diagram illustrating the use of text-based files to build applications in accordance with another embodiment of the present invention. In this embodiment, one or more of the XML files within a set of XML files 310 can be modified to customize an application C 350 according to the preferences of the end-user. For example, the file or files defining the user interface can be differentiated into a first user interface file 331 and a second user interface file 332, while other files in the set of XML files 310 are not differentiated. Thus, different user interfaces can be provided to client computer systems 190a and 190b for the same application C 350. It is appreciated that other files (e.g., the business, communication and/or data files) within the set of XML files 310 can also be modified according to a user's preference(s). In this manner, an application or set of applications can be customized on a device-by-device basis.

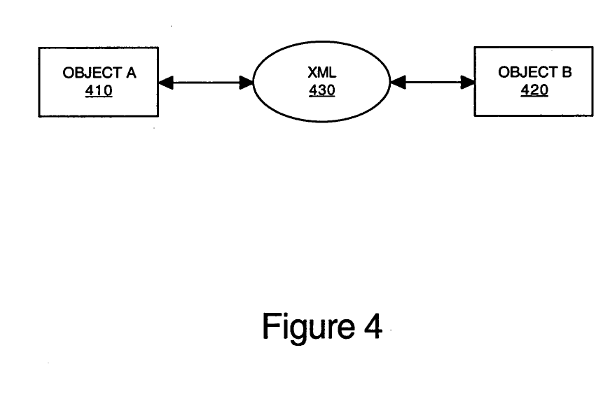

FIG. 4 is a data flow diagram showing the interaction of application objects in accordance with one embodiment of the present invention. In accordance with the present embodiment of the present invention, applications are comprised of objects (e.g., A 410 and B 420) that communicate by passing XML messages 430 to each other. Objects A 410 and B 420 can reside on a client computer system (e.g., 190a) or on a server computer system 190c (FIG. 2). An object is typically in one of the two states: a listen state or a talk state. The present invention coordinates communication between objects A 410 and B 420. For example, in one embodiment, agent 205 (FIG. 2) functions to ensure that at least one of the objects is in the listen state.

FIG. 5 is a flowchart of the steps in a process 500 for building applications from text-based files in accordance with one embodiment of the present invention. In this embodiment, process 500 is implemented by computer system 190 as computer-readable program instructions (agent 205 of FIG. 2) stored in a memory unit (e.g., ROM 103, RAM 102 or data storage device 104 of FIG. 1) and executed by a processor (e.g., processor 101 of FIG. 1). As described above, in one embodiment, the text-based files use XML or an XML syntax.

In step 510 of FIG. 5, with reference also to FIG. 2, a shell program (e.g., agent 205) is installed on each of client computer systems 190a-b. Agent 205 can be downloaded on each client from server computer system 190c, or otherwise installed using some type of transferable memory unit such as a compact disk. In accordance with the present invention, agent 205 is a generic (e.g., cross-platform and cross-device) program. It is contemplated that agent 205 would only be installed once on client computer systems 190a-b.

In step 520 of FIG. 5, again with reference also to FIG. 2, text-based files (e.g., XML files) are received by client computer systems 190a-b from server computer system 190c. The files define the various components and objects of each of the applications to be executed by the clients. In the present embodiment, the files are used to define, for each application, the graphical user interface, business rules (e.g., functions and operations), communication preferences (e.g., between each of the clients 190a-b and server 190c), and data flow and management used by the application.

In step 530, agent 205 residing on a client computer system (e.g., 190a) is executed. In accordance with the present invention, agent 205 functions to assemble the files received in step 520 into each of the various applications defined by those files.

In step 540, agent 205 meshes the files received in step 520 into different client-based applications.

In step 550, applications can be readily updated by downloading and installing a new file (or files) that replace a previously used file. That is, in the present embodiment, an individual component or object of an application is updated by downloading a different version of a file corresponding to that component/object. Updates can be performed on a periodic basis, for example at regular intervals specified by each user or specified in the files that define communication preferences for each of the applications. Updates can also be performed each time the client computer system is connected with the server computer system, either automatically or in response to user input (e.g., the user can click on the “refresh” button of the client-based Web browser). In any case, updates are performed and implemented seamlessly and transparently to the user.

Thus, if an enterprise wants to change the manner in which it does business (for example, the business wants to record and track business data differently from before), the appropriate file or files can be modified at the server and then sent to each client as the client comes into use. Because the XML format is used, such modifications are readily made.

In a similar manner, a user can specify preferences with regard to the user interface. A user's preferences can be specified by the user interacting with the server, or the user's preferences can be cached on either the client or server device. Based on the user's preferences, the appropriate field in the XML file can be modified, so that when the file is received by the client, the desired user interface is displayed.

The preferred embodiment of the present invention, centrally managed and distributed applications, is thus described. While the present invention has been described in particular embodiments, it should be appreciated that the present invention should not be construed as limited by such embodiments, but rather construed according to the following claims.

1. A method for implementing an application on a client computer system, said method comprising:
a) receiving at said client computer system a plurality of text files wherein each of said text files defines a component of said application;
b) executing a program resident on said client computer system, wherein said program comprises instructions for using a combination of said text files to create said application;
c) creating said application on said client computer system from said text files executing in combination according to said program; and
d) checking automatically for updated versions of said text files.

2. The method as recited in claim 1 wherein said text files use an Extensible Markup Language (XML) syntax.

3. The method as recited in claim 1 wherein said client computer system is communicatively coupled to a server computer system in a computer system network, wherein said server system provides a central source for managing and distributing applications and modifications to applications.

4. The method as recited in claim 3 wherein said plurality of text files received in said step a) are received from said server computer system.

5. The method as recited in claim 3 comprising:
executing said application on said client computer system in an asynchronous mode, wherein said asynchronous mode comprises:
i) sending a request from said client computer system to said server computer system; and
ii) executing said application in parallel with and while waiting for a response to said request.

6. The method as recited in claim 3 comprising:
executing said application on said client computer system in a connectionless mode in the absence of communication between said client computer system and said server computer system.

7. The method as recited in claim 1 wherein said plurality of text files received in said step a) are particular to said client computer system.

8. The method as recited in claim 1 comprising:
receiving a new text file defining a component of said application, wherein said new text file is used in lieu of a previously received text file to modify said application.

9. The method as recited in claim 1 wherein said component of said application pertains to a graphical user interface.

10. The method as recited in claim 1 wherein said component of said application pertains to communication preferences.

11. The method as recited in claim 1 wherein said component of said application pertains to data management.

12. The method as recited in claim 1 wherein said component of said application pertains to logic used with said application.

13. A computer system comprising:
a bus;
a computer-readable memory unit coupled to said bus; and
a processor coupled to said bus, said processor for executing a method for implementing an application comprising:
a) receiving at said computer system a plurality of text files wherein each of said text files defines a component of said application;
b) executing a program resident on said computer system, wherein said program comprises instructions for using a combination of said text files to create said application;
c) creating said application on said computer system from said text files executing in combination according to said program; and
d) uploading results from using said application to a server computer system.

14. The computer system of claim 13 wherein said text files use an Extensible Markup Language (XML) syntax.

15. The computer system of claim 13 wherein said computer system is communicatively coupled to said server computer system in a computer system network, wherein said server system provides a central source for managing and distributing applications and modifications to applications.

16. The computer system of claim 15 wherein said plurality of text files received in said step a) of said method are received from said server computer system.

17. The computer system of claim 15 wherein said method comprises:
executing said application on said client computer system in an asynchronous mode, wherein said asynchronous mode comprises:
i) sending a request from said client computer system to said server computer system; and
ii) executing said application in parallel with and while waiting for a response to said request.

18. The computer system of claim 15 wherein said method comprises:
executing said application on said client computer system in a connectionless mode in the absence of communication between said client computer system and said server computer system.

19. The computer system of claim 13 wherein said plurality of text files received in said step a) of said method are particular to said computer system.

20. The computer system of claim 13 wherein said method comprises:
receiving a new text file defining a component of said application, wherein said new text file is used in lieu of a previously received text file to modify said application.

21. The computer system of claim 13 wherein said component of said application pertains to a graphical user interface.

22. The computer system of claim 13 wherein said component of said application pertains to communication preferences.

23. The computer system of claim 13 wherein said component of said application pertains to data management.

24. The computer system of claim 13 wherein said component of said application pertains to logic used with said application.

25. A computer-usable medium having computer-readable program code embodied therein for causing a computer system to perform a method comprising:
a) installing on said computer system a plurality of text files wherein each of said text files defines a component of said application;
b) installing a program on said computer system, wherein said program comprises instructions for using a combination of said text files to create said application;
c) creating said application on said computer system from said text files executing in combination according to said program; and
d) receiving automatically any updated versions of said text files in response to said program checking for said updated versions.

26. The computer-usable medium of claim 25 wherein said text files use an Extensible Markup Language (XML) syntax.

27. The computer-usable medium of claim 25 wherein said computer system is communicatively coupled to a server computer system in a computer system network, wherein said server system provides a central source device for managing and distributing applications and modifications to applications.

28. The computer-usable medium of claim 27 wherein said plurality of text files installed in said step a) are received from said server computer system.

29. The computer-usable medium of claim 27 wherein said computer-readable program code embodied therein causes a computer system to perform said method comprising:
executing said application on said computer system in an asynchronous mode, wherein said asynchronous mode comprises:
i) sending a request from said computer system to said server computer system; and
ii) executing said application in parallel with and while waiting for a response to said request.

30. The computer-usable medium of claim 27 wherein said computer-readable program code embodied therein causes a computer system to perform said method comprising:
executing said application on said computer system in a connectionless mode in the absence of communication between said computer system and said server computer system.

31. The computer-usable medium of claim 25 wherein said plurality of text files installed in said step a) are particular to said computer system.

32. The computer-usable medium of claim 31 wherein said computer-readable program code embodied therein causes a computer system to perform said method comprising:
installing on said computer system a new text file defining a component of said application, wherein said new text file is used in lieu of a previously received text file to modify said application.

33. The computer-usable medium of claim 25 wherein said component of said application pertains to a graphical user interface.

34. The computer-usable medium of claim 25 wherein said component of said application pertains to communication preferences.

35. The computer-usable medium of claim 25 wherein said component of said application pertains to data management.

36. The computer-usable medium of claim 25 wherein said component of said application pertains to logic used with said application.
